(19) United States
(12) Patent Application Publication
(10) Pub. No.: US 2014/0201618 A1
(43) Pub. Date: Jul. 17, 2014

(54) CLIENT-SIDE PERSONALIZATION OF WEBSITES AND CORRESPONDING NETWORK ENVIRONMENT

(71) Applicant: INTERNATIONAL BUSINESS MACHINES CORPORATION, ARMONK, NY (US)

(72) Inventors: UWE HANSMANN, TUBINGEN (DE); THOMAS STOBER, HERRENBERG (DE)

(73) Assignee: INTERNATIONAL BUSINESS MACHINES CORPORATION, ARMONK, NY (US)

(21) Appl. No.: 14/146,814

(22) Filed: Jan. 3, 2014

(30) Foreign Application Priority Data
Jan. 15, 2013 (GB) 1300686.1

(51) Int. Cl. G06F 17/22

(52) U.S. Cl. CPC G06F 17/2247
USPC 715/234

(57) ABSTRACT

A method and/or computer program product provides client-side personalization of websites. A client and a web server are provided with a description language infrastructure that provides classifying categories for web content. A browser locally defines user preferences for web content as description language classifying categories for web content. Web content is requested and received from the web server as a response, which includes the requested web content and a markup with description language information specifying all alternatives of classifying categories for web content fragments of the web content. The classifying categories are locally filtered for web content fragments of the web content based on said locally defined user preference. A personalized subset of the web content is displayed based on the locally defined user preferences.

This application is based on and claims the benefit of priority from United Kingdom (GB) Patent Application 1300686.1, filed on Jan. 15, 2013, and herein incorporated by reference in its entirety.

### BACKGROUND

The present invention relates in general to the field of websites personalization in a network environment, and in particular to a method for client-side personalization of websites and a corresponding network environment. Still more particularly, the present invention relates to a data processing program and a computer program product for client-side personalization of websites.

Enterprise portals provide powerful capabilities for rendering dynamic web pages and content. They allow personalizing of the page layout to show contextual information and to tailor an entire web site to the end users need.

Nevertheless portals are typically complex software stacks, which require tedious installation and ongoing administration. In many customer situations, only very little “portal”-like capabilities are actually needed and a sophisticated portal product such as WebSphere portal is too costly and too much effort to maintain. Further classic portals store user specific data at server side infrastructure which could lead to difficulties in maintaining user's privacy. Sometimes it is sufficient to only have the web page simply emphasize information of a certain category, which is important for a particular user.

One important technology to shape the web page in a flexible parameterized way is cascading style sheets, for example CSS3 (Cascading Style Sheets Level 3). The cascading style sheets (CSS) is a style sheet language used for describing the presentation semantics, i.e. look and formatting, of a document written in a markup language. The most common application of the style sheet language is to style web pages written in HTML and XHTML, but the style sheet language can also be applied to any kind of XML document, including plain XML, SVL and XUL. The cascading style sheet language defines styles, which browsers apply when rendering HTML markup. The same HTML markup can look very different, if different cascading style sheets are associated. In the latest revisions of the cascading style sheets language it is also possible to have alternative cascading style sheet styles, based on the used device and browser capabilities. This technique is called “media query”. Media queries is a module of the cascading style sheet language allowing to adapt the rendering of web pages based on conditions such as screen resolution (e.g. smartphone vs. high definition screen).

A media query consists of a media type and one or more expressions, involving media features, which resolve to either true or false. The result of the query is true if the media type specified in the media query matches the type of device the document is being displayed on and all expressions in the media query are true. When a media query is true, the corresponding style sheet or style rules are applied, following the normal cascading rules. A media type can be declared in the head of an HTML document using the “media” attribute inside of a <link> element. The value of the “media” attribute specifies on what device the linked document will be displayed. Media types can also be declared within XML processing instructions, the @import at-rule, and the @media at-rule.

Known prior art in this field includes providing in the form of a markup language document a service comprising service content, service presentation and service behavior. Before the document is executed by a program module called markup language processor, at least one user parameter is determined from a user profile, a user input and/or current network characteristics. Then the service behavior is adapted based on the user parameter by transforming the markup language document using a behavior style sheet. After transformation, the markup language document is executed. A server side content categorization which can be leveraged in client side browser to only selectively visualize certain information is not disclosed.

Other known prior art in this field describes a system and method for providing client side personalization of content of web pages and the like is disclosed. It is suggested to send not personalized markup by a web server to a browser. The browser displays that markup as it is without personalization. Nevertheless the markup includes conditional hook points, which link to further “supplemental” information from different sources in the web. This further information is loaded by the browser in separate subsequent requests and is inserted inside the browser to the original page. It is not suggested to send a single/coherent/seamless page to the browser, which holds all information needed including the categorization of individual content pieces of the web page.

### SUMMARY

In one embodiment of the present invention, a method and/or computer program product provides client-side personalization of websites. A client and a web server are provided with a description language infrastructure that provides classifying categories for web content. A browser locally defines user preferences for web content as description language classifying categories for web content. Web content is requested and received from the web server as a response, which includes the requested web content and a markup with description language information specifying all alternatives of classifying categories for web content fragments of the web content. The classifying categories are locally filtered for web content fragments of the web content based on said locally defined user preference. A personalized subset of the web content is displayed based on the locally defined user preferences.

In one embodiment of the present invention, a network environment comprises: at least one client and at least one web server, wherein said at least one client and said at least one web server both comprise a description language infrastructure that provides classifying categories for web content; a browser on said at least one client, wherein said browser locally defines user preferences for web content as description language classifying categories; wherein said at least one web server stores defined markups with description language information reflecting all alternatives of classifying categories for web content fragments used in said at least one web server; wherein said at least one client requests web content from said at least one web server and receives a response from said at least one web server, wherein said response comprises said requested web content and markup with description language information specifying all alternatives of classifying categories for web content fragments of said requested web content; wherein said browser processes said markup and locally filters said classifying categories for web content fragments of said web content based on said locally defined user preferences; and a display, wherein the display displays a personalized subset of said web content based on said locally defined user preferences.

### BRIEF DESCRIPTION OF THE SEVERAL VIEWS OF THE DRAWINGS

A preferred embodiment of the present invention, as described in detail below, is shown in the drawings, in which:

FIG. 1 is a schematic block diagram of a network environment, in accordance with an embodiment of the present invention;

FIG. 2 is a schematic diagram of an input mask of a user interface to specify parameters/values for personalization preferences at the client device, in accordance with an embodiment of the present invention;

FIG. 3 is a schematic flow diagram of a method for client-side personalization of websites, in accordance with an embodiment of the present invention;

FIG. 4 is a schematic flow diagram of a client side process being part of the method for client-side personalization of websites, in accordance with an embodiment of the present invention; and

FIG. 5 is a schematic flow diagram of a server side process being part of the method for client-side personalization of websites, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

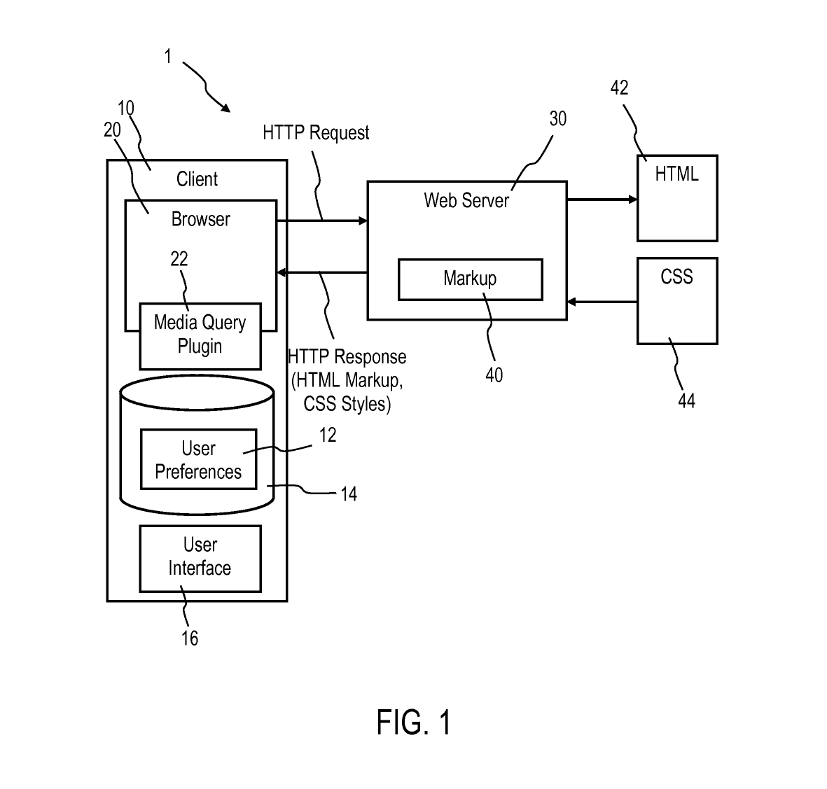

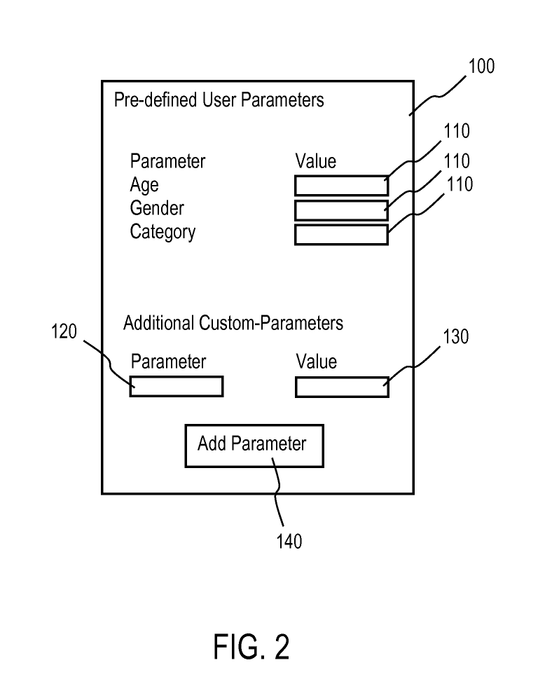

FIG. 1 shows a network environment 1, in accordance with an embodiment of the present invention; and FIG. 2 shows an input mask 100 of a user interface to specify parameters/values for personalization preferences at the client device 10, in accordance with an embodiment of the present invention.

Referring to FIG. 1, the shown embodiment of the present invention employs a network environment 1 comprising at least one client 10 and at least one web server 30 both with a description language infrastructure providing classifying categories for web content. A browser 20 of the client 10 defines user preferences 12 locally as description language classifying categories. The locally defined user preferences 12 are stored in a local storage 14 of the client 10, for example. The web server 30 stores defined markups 40 with description language information reflecting all alternatives of classifying categories for web content fragments used in the web server 30. The client 10 requests web content 42, for example a HTML document, from the web server 30 and receives a response from the web server 30, comprising the requested web content 42 and markup 40 with description language information specifying all alternatives of classifying categories for web content fragments of the requested web content 42. The browser 20 processes the markup 40 and filters locally the classifying categories for web content fragments of the web content 42 based on the locally defined user preferences 12; and displays a personalized subset of the web content 42 based on the locally defined user preferences 12.

The browser 20 compares the locally defined user preferences 12 with the classifying categories for web content fragments of the web content 42 during filtering; and only web content fragments of the web content 42 with a correlating classifying category is part of the personalized subset of the displayed web content.

Referring to FIG. 1 and FIG. 2, the client 10 comprises a user interface 16 configured to edit parameters reflecting the user preferences 12 and usable by the description language infrastructure; and wherein the user interface 16 displays an input mask 100 to the user. In the shown embodiment the user preferences 12 comprise pre-defined parameters like age, gender and category of interest, and an additional custom-parameter 120. The user is able to input values 110, 130 to specify the corresponding pre-defined parameters or the additional parameter 120. The mask 100 further comprises a soft switch 140 to add the additional custom-parameter 120 and the corresponding parameter values 110, 130 to the user preferences 12.

In the shown embodiment the description language infrastructure is configured as extended media query infrastructure of a cascading style sheet language providing attributes and/or values to classify categories for web content.

The media query syntax is described in terms of the CSS2 Cascading Style Sheets Level 2 grammar. As such, rules not defined here are defined in CSS2. The media query list production defined below replaces the media list production from CSS2.

media_query_list

: S* [media_query [‘,’ S* media_query ]* ]?
;

media_query

: [ONLY | NOT]? S* media_type S* [AND S* expression ]*
| expression [ AND S* expression ] *
;

media_type

: IDENT
;

expression

: ‘(′ S* media_feature S* [ ‘:′ S* expr ]? ‘)’ S*
;

media_feature

: IDENT
;

Syntactically, media features resemble cascading style sheets properties. They have names and accept certain values. There are, however, several important differences between properties and media features. Properties are used in declarations to give information about how to present a document. Media features are used in expressions to describe requirements of the output device. Most media features accept optional “min-” or “max-” prefixes to express “greater or equal to” and “smaller or equal to” constraints. This syntax is used to avoid “<” and “>” characters which may conflict with HTML and XML. Those media features that accept prefixes will most often be used with prefixes, but can also be used alone. Properties always require a value to form a declaration. Media features, on the other hand, can also be used without a value. For a media feature “feature”, (feature) will evaluate to true if (feature: x) will evaluate to true for a value x other than zero or zero followed by a unit identifier (i.e., other than 0, 0px, 0em, etc.). Media features that are prefixed by min/max cannot be used without a value. When a media feature prefixed with min/max is used without a value it makes the media query malformed. Properties may accept more complex values, e.g., calculations that involve several other values. Media features only accept single values: one keyword, one number, or a number with a unit identifier. The only exceptions are the “aspect-ratio” and “device-aspect-ratio” media features.

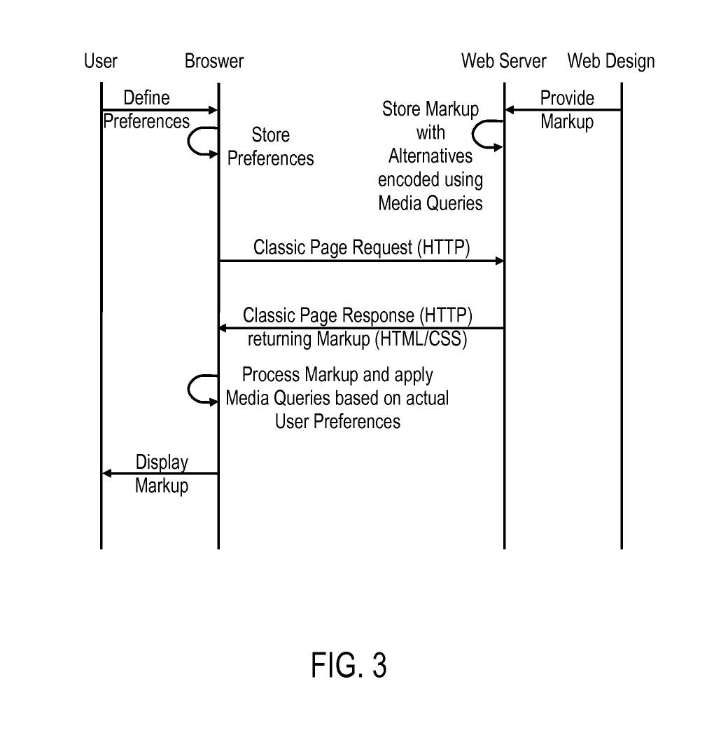

FIG. 3 shows a method for client-side personalization of websites, in accordance with an embodiment of the present invention.

Referring to FIG. 1 to FIG. 3, an end-user can define preferences 12 in the browser 20 which reflect his interests and desired personalization. These user preferences 12 are local to the user client system 10 and stored in the local storage 14 of the client 10. They are not shared with the web server 30. The web server 30 will not gain any knowledge of his personal interests. This information is kept private. This is one part of the inventive concept. As described above, the browser 20 is extended to offer a user interface 16, which allows editing parameters, which can be picked up by the CSS3 media query framework. State of the art media queries are only designed to pick up device specific hardcoded attributes/values, which define e.g. screen width, color, resolution, etc. This technique is extended to also allow users to add personal preferences/personalization information like gender (male, female), max-age (integer), interests (sports, news, politics), which the browser 20 should apply.

Rather than assembling a personalized, dynamic web page from user-specific HTML fragments and sending that targeted web content to the browser 20 of the user client 10, the web server 30 sends the same non-personalized web page 42 to each user. This generic web site flags for each HTML fragment, which interest, audiences, and/or user segments it addresses. The generic web site 42 can also flag alternative HTML fragments for different audiences. These “rules” are defined using media queries of the cascading style sheet language 44. The properties reflecting interests and user preferences could be standardized as a common description language to make them usable with different independent web sites.

Regular HTML pages 42 are created by classical means of web design. They also take advantage of CSS3 styles 44 to define the look and feel. This is a standard way of designing “styles” in a versatile way. The web page 42 can take advantage of media queries, e.g. to omit certain content (visibility rules) and choose between entirely different layouts. It is possible to define different styles which bring forward different content/pieces of web markup 40. It is also possible to let browser automatically fetch additional markup/CSS under certain conditions. Further the web server 30 may present parameters for defining user preferences 12 to the client 10 the web server 30 supports. In addition to the state of the art features of “media-query” or “min-width/max-width”, which deal with specific characteristics/capabilities of browsers and devices, the web designer can also make decisions based on end-users preferences e.g. @media=“Sports and (min-age: 30) and (gender: male)” {<definitions of styles and content goes here>. So the web designer provides the markups to the web server 30. The web server 30 stores all alternative markups 40 with description language information reflecting all alternatives of classifying categories for web content fragments used in the web server 30.

The browser 20 transmits a classic page request to the web server 30 and receives a classic page response from the web server 30 comprising the requested web content 42 and markup 40 with description language information specifying all alternatives 44 of classifying categories for web content fragments of the web content 42. The browser 20 executes the media queries coming from the web server 30, based on the preferences 12 the user has stored on his client system 10. This step will filter the generic HTML from the web server 30 and display a personalized subset in the browser 20, which target the user's wishes and preferences 12. Without sharing his interests to the web server 30, e.g. due to privacy concerns, the user can retrieve a personalized web experience. The browser 20 evaluates the CSS and the included media queries. The web page will be displayed according to the requested user specific parameters.

Instead of asking a user to manually set preferences 12 within his browser 20, which reflects his interests and which can be queried by media queries, for example, even more automation could be applied. The browser 20 may comprise a media query plugin 22 performing a local website analysis to detect habits and interests of the user. The media query plugin 22 then analyzes the habits and interests of the user to define the user preferences 12 automatically. If a customer prefers to automatically receive web content adapted to his web browsing habits, it is conceivable that the plugin 22 within the browser 20 performs a local web site analytics and detects the user's habits and interests. Based on the analytics, this local plugin 22 can automatically set the parameters 12, which, for example, can be queried by the media queries inside the cascading style sheets language delivered by the web sites. Without any specific action, a user's browser 20 can learn and ensure the displayed web sites reflect the user's preferences accordingly, assuming the web site is based on HTML5/CSS3 which includes corresponding media query enabled markup.

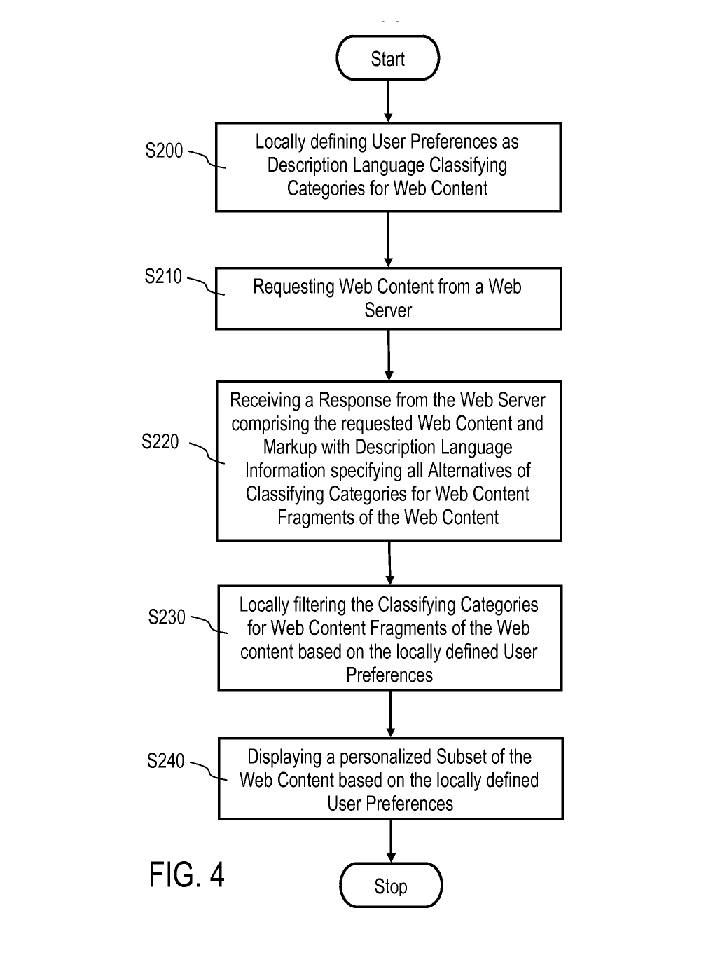

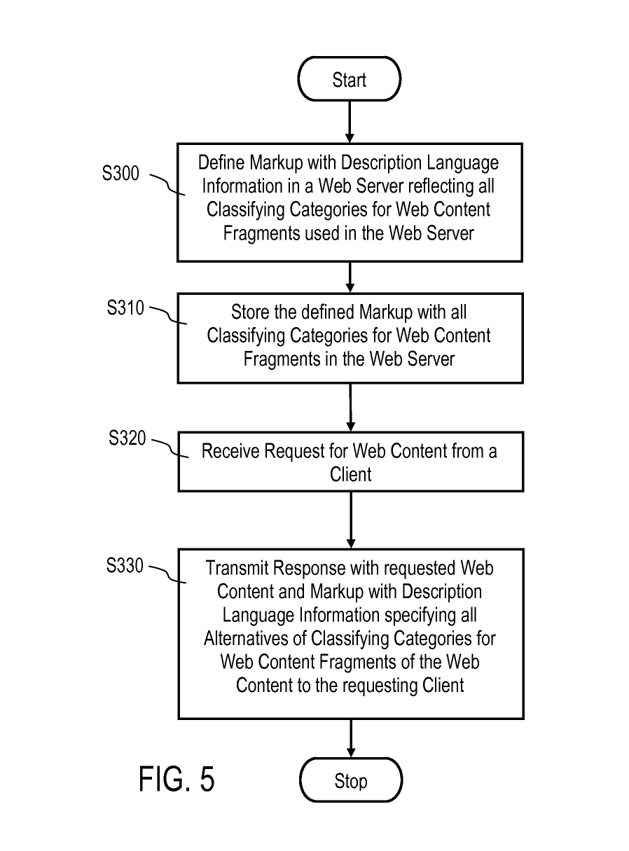

FIG. 4 shows a client-side process being part of the method for client-side personalization of websites, in accordance with an embodiment of the present invention; and FIG. 5 shows a server-side process being part of the method for client-side personalization of websites, in accordance with an embodiment of the present invention. According to embodiments of the inventive method for client-side personalization of websites at least one client 10 and at least one web server 30 are provided both with a description language infrastructure providing classifying categories for web content.

Referring to FIG. 4, in step S200 user preferences 12 are locally defined as description language classifying categories for web content using a browser 20. In step S210 web content 42 is requested from the web server 30. In step S220 a response is received from the web server 30 comprising the requested web content 42 and markup 40 with description language information specifying all alternatives 44 of classifying categories for web content fragments of the web content 42. In step S230 the classifying categories are locally filtered for web content fragments of the web content 42 based on the locally defined user preferences 12. In step S240 a personalized subset of the web content is displayed based on the locally defined user preferences 12.

Referring to FIG. 5, in step S300 markup 40 with description language information is defined in the web server 30 reflecting all classifying categories for web content fragments used in the web server 30. In step S310 the defined markup 40 is stored with all classifying categories for web content fragments in the web server 30. In step S320 the web server 30 receives a request for web content 42 from the client 10. In step S330 the web server 30 transmits the response with the requested web content 42 and markup 40 with description language information specifying all alternatives of classifying categories for web content fragments of the web content 42 to the requesting client 10.

The technical problem underlying the present invention is to provide a method for client-side personalization of websites and a corresponding network environment, which are able to implement personalization preferences at the client device based on classifying categories for web content and to solve the above mentioned shortcomings and pain points of prior art personalization of websites.

As described herein, according to the present invention this problem is solved by providing a client-side personalization of websites, including those described in the present specification and in the claims appended hereto.

Accordingly, in an embodiment of the present invention a method for client-side personalization of websites comprises the steps of: providing a client and a web server both with a description language infrastructure providing classifying categories for web content; locally defining user preferences as description language classifying categories for web content using a browser; requesting web content from the web server; receiving a response from the web server comprising the requested web content and markup with description language information specifying all alternatives of classifying categories for web content fragments of the web content; locally filtering the classifying categories for web content fragments of the web content based on the locally defined user preferences; and displaying a personalized subset of the web content based on the locally defined user preferences.

In further embodiments of the present invention, the locally defined user preferences are stored in a local storage of the client.

In further embodiments of the present invention, the locally defined user preferences are compared with the classifying categories for web content fragments of the web content during filtering; and only web content fragments of the web content with a correlating classifying category is part of the personalized subset of the displayed web content.

In further embodiments of the present invention, the description language infrastructure is configured as extended media query infrastructure providing attributes and/or values to classify categories for web content.

In further embodiments of the present invention, the markup comprises categorized content information, which flags each web content fragment, which user preference the web content fragment addresses.

In further embodiments of the present invention, the content information flags alternatively web content fragments for different user preferences.

In further embodiments of the present invention, the user preferences comprise pre-defined parameters like age, gender and/or category of interest, and additional custom-parameters.

In further embodiments of the present invention, the web server presents parameters for defining user preferences to the client the web server supports.

In another embodiment of the present invention, a network environment comprises at least one client and at least one web server both with a description language infrastructure providing classifying categories for web content. A browser of the client defines user preferences locally as description language classifying categories. The web server stores defined markups with description language information reflecting all alternatives of classifying categories for web content fragments used in the web server. The client requests web content from the web server and receives a response from the web server, comprising the requested web content and markup with description language information specifying all alternatives of classifying categories for web content fragments of the requested web content. The browser processes the markup and filters locally the classifying categories for web content fragments of the web content based on the locally defined user preferences; and displays a personalized subset of the web content based on the locally defined user preferences.

In further embodiments of the present invention, the description language infrastructure is configured as extended media query infrastructure providing attributes and/or values to classify categories for web content.

In further embodiments of the present invention, the client comprises a user interface configured to edit parameters reflecting the user preferences and usable by the description language infrastructure; and wherein the user interface displays an input mask to the user.

In further embodiments of the present invention, the browser comprises a media query plugin performing a local website analysis to detect habits and interests of a user.

In further embodiments of the present invention, the media query plugin analyzes the habits and interest of the user to define the user preferences automatically.

In another embodiment of the present invention, a data processing program for execution in a data processing system comprises software code portions for performing a method for client-side personalization of websites when the program is run on the data processing system.

In yet another embodiment of the present invention, a computer program product stored on a computer-usable medium, comprises computer-readable program means for causing a computer to perform a method for client-side personalization of websites when the program is run on the computer.

All in all, embodiments of the present invention are able to implement personalization preferences at the client device based on classifying categories for web content using a description language infrastructure without the need of sharing personal end user preferences with the server side infrastructure and without storing such data on the server. All personal data is kept locally.

A core idea of the present invention is to extend the concept of a description language infrastructure, like media queries of the cascading style sheet language and allow users to configure personal preferences and/or categories in addition to the state of the art browser and/or device capabilities.

Embodiments of the present invention offer a very lightweight portal-like personalization based on rough categories like gender, age, interests etc., which can be set by individual users. This approach can be applied to any simple HTTP web server or web application server like WebSphere application server, for example.

The advantage of the approach is its simplicity. The implementation effort is extremely small. The markup used for the web site is based on standards. All customization is defined by the user in his client-side browser as an attribute in an extended media query infrastructure, for example. The browser product comprises a user interface which allows the end-user to add or edit his media query preferences. A web designer can create versatile markup and styles which take under account which media query preferences are defined by the user within his browser.

As the personalization wishes of the user are defined within his client-side browser they can be applied to any web site, which uses the defined parameters within media queries, for example. The website could also present the user with a pop-up that allows him to set the parameters the website supports, for the user's next visit.

The downside is that the portal-personalization capability is limited to a set of different views based on those categories. But this is acceptable for customers who are only seeking a very cheap and simple “portal”.

This idea could also be taken one step further. Instead of asking a user to manually set preferences within his browser, which reflect his interests and which can be queried by media queries, for example, even more automation could be applied. If a customer prefers to automatically receive content adapted to his web browsing habits, it is conceivable that a plug in within the browser performs a local web site analytics and detects the user's habits and interests. Based on the analytics, this local plug in can automatically set the parameters, which, for example, can be queried by the media queries inside the cascading style sheets language delivered by the web sites. Without any specific action, a user's browser can learn and ensure the displayed web sites reflect the user's preferences accordingly, assuming the web site is based on HTML5/CSS3 which includes corresponding media query enabled markup.

The above, as well as additional purposes, features, and advantages of the present invention will become apparent in the following detailed written description.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for client-side personalization of websites, the method comprising:
providing both a client and a web server with a description language infrastructure that provides classifying categories for web content;
locally defining, via a browser, user preferences for web content as description language classifying categories for web content;
requesting, by one or more processors, web content from said web server;
receiving, by one or more processors, a response from said web server, wherein said response comprises said requested web content and a markup with description language information specifying all alternatives of classifying categories for web content fragments of said web content;
locally filtering, by one or more processors, said classifying categories for web content fragments of said web content based on said locally defined user preferences; and
displaying a personalized subset of said web content based on said locally defined user preferences.

2. The method according to claim 1, wherein said locally defined user preferences are stored in a local storage of said client.

3. The method according to claim 1, wherein said locally defined user preferences are compared with said classifying categories for web content fragments of said web content during filtering, and wherein only web content fragments of said web content with a correlating classifying category is part of said personalized subset of said displayed web content.

4. The method according to claim 1, wherein said description language infrastructure is configured as extended media query infrastructure providing attributes and values to classify categories for web content.

5. The method according to claim 1, wherein said markup comprises categorized content information, wherein said categorized content information flags each web content fragment, and wherein said categorized content information identifies which user preference said web content fragment addresses.

6. The method according to claim 5, wherein said content information flags alternative web content fragments for different user preferences.

7. The method according to claim 1, wherein said user preferences comprise pre-defined parameters like age, gender and/or category of interest, and additional custom-parameters.

8. The method according to claim 1, wherein said web server presents parameters for defining user preferences to said client that said web server supports.

9. A network environment comprising:
at least one client and at least one web server, wherein said at least one client and said at least one web server both comprise a description language infrastructure that provides classifying categories for web content;
a browser on said at least one client, wherein said browser locally defines user preferences for web content as description language classifying categories;
wherein said at least one web server stores defined markups with description language information reflecting all alternatives of classifying categories for web content fragments used in said at least one web server;
wherein said at least one client requests web content from said at least one web server and receives a response from said at least one web server, wherein said response comprises said requested web content and markup with description language information specifying all alternatives of classifying categories for web content fragments of said requested web content;
wherein said browser processes said markup and locally filters said classifying categories for web content fragments of said web content based on said locally defined user preferences; and
a display, wherein the display displays a personalized subset of said web content based on said locally defined user preferences.

10. The network environment according to claim 9, wherein said description language infrastructure is configured as extended media query infrastructure providing attributes and values to classify categories for web content.

11. The network environment according to claim 9, wherein said at least one client comprises a user interface configured to edit parameters reflecting said user preferences and usable by said description language infrastructure, and wherein said user interface displays an input mask to a user interface to specify parameters for personalization preferences at said at least one client device.

12. The network environment according to claim 10, wherein said browser comprises a media query plugin performing a local website analysis to detect habits and interests of a user.

13. The network environment according to claim 12, wherein said media query plugin analyzes said habits and interest of said user to automatically define said user preferences.

14. A computer program product for client-side personalization of websites, the computer program product comprising a computer readable storage medium having program code embodied therewith, the program code readable and executable by a processor to perform a method comprising:
providing both a client and a web server with a description language infrastructure that provides classifying categories for web content;
locally defining, via a browser, user preferences as description language classifying categories for web content;
requesting, by one or more processors, web content from said web server;
receiving a response from said web server, wherein said response comprises said requested web content and a markup with description language information specifying all alternatives of classifying categories for web content fragments of said web content;
locally filtering, by one or more processors, said classifying categories for web content fragments of said web content based on said locally defined user preferences; and
displaying a personalized subset of said web content based on said locally defined user preferences.

15. The computer program product of claim 14, wherein said locally defined user preferences are stored in a local storage of said client.

16. The computer program product of claim 14, wherein said locally defined user preferences are compared with said classifying categories for web content fragments of said web content during filtering; and only web content fragments of said web content with a correlating classifying category is part of said personalized subset of said displayed web content.

17. The computer program product of claim 14, wherein said description language infrastructure is configured as extended media query infrastructure providing attributes and/or values to classify categories for web content.

18. The computer program product of claim 14, wherein said markup comprises categorized content information, wherein said categorized content information flags each web content fragment, and wherein said categorized content information identifies which user preference said web content fragment addresses.

19. The computer program product of claim 18, wherein said content information flags alternative web content fragments for different user preferences.

20. The computer program product of claim 14, wherein said web server presents parameters for defining user preferences to said client that said web server supports.
